(19) United States
(12) Patent Application Publication
(10) Pub. No.: US 2011/0320336 A1
(43) Pub. Date: Dec. 29, 2011

(54) SYSTEM AND A METHOD FOR GENERATING MARKET INPUT

(75) Inventors: Johan L. OLSSON, Tyreso (SE); Lars Bemersjö, Hedemora (SE)

(73) Assignee: OMX TECHNOLOGY AB, Stockhol (SE)

(21) Appl. No.: 12/825,691

(22) Filed: Jun. 29, 2010

(51) Int. Cl. G06Q 40/00

(52) U.S. Cl. 705/37

(57) ABSTRACT

Provided is a system and a method for entering market actions into an automated exchange system (200). More specifically the automated exchange system (200) and the method enables automatic generation of input data messages comprising new, altered or cancelled orders and, or, quotes to be sent to a matching module (203) via an internal, interface (205). Thus, the invention provides algorithmic trade participants with tools for installing algorithmic trade units directly into the automated exchange system (200). The automated exchange system (200) and the method allows a full trading cycle to be performed with low latency and reduce the amount of data directed to-, and from the automated exchange system (200).

### TECHNICAL FIELD

Present invention relates to a method and a system for trading in automated exchange, and more particularly it relates to a computer system enabling, and a method for, entering market input data into an automated exchange.

### BACKGROUND

The financial industry is a very important contributor for development of society. For example, the financial industry makes it possible, amongst other, for various companies to obtain investment money or to secure themselves from different kinds of financial risks and so forth. A strong financial industry is thus essential for trade, industry and economical development.

In the past ten-, to twenty years the financial industry has had a very rapid development, mainly due to technological advances in computing technology, transaction technology and information technology. As a result of the rapid development in the financial industry, more participants than ever; i.e. companies and people, are connected to existing financial systems; typically electronic exchange systems. The increase of participants being connected to the electronic exchange systems has thus also increased the amount of data, typically in form of standardized messages, sent to and from these electronic exchange systems. Furthermore, the development of algorithmic trading has also, even further, increased the amount of data messages being sent into said electronic exchange systems.

A conventional electronic exchange system typically receives input data in form of data messages, primarily from external devices used by traders. The data messages are typically for submitting orders, alterations/cancellations thereof and/or quotes, to the electronic exchange system. The orders, or quotes, typically relates to buying and/or selling of any type of financial instrument. In particular the input data messages typically relates to an order message representing submitting a new bid-, or sell order, or a new quote into the electronic exchange system. The input data message may also represent a change of an existing bid-, or sell order, or a quote. In addition to the above the input data message may represent a cancellation, or change, of an existing bid-, or sell order, or a quote.

Thus as has been established above, during the last decade, or so, the number of financial transactions taking place at various electronic exchange systems has increased. Shares at electronic exchange systems are nowadays typically traded in the billions, each and every market day.

However, in order for a trade to actually take place, the exchange system matches a buy order against a sell order, for each and every instrument. Each performed trade in an instrument thus requires at least two orders to be entered into the exchange system and with the amount of trades increasing, the numbers of market actions (for example buy/sell orders, buy/sell quotes, update orders and delete orders) sent to the exchange system also increases.

FIG. 1 illustrates a typical system architecture providing an automated exchange system. In FIG. 1 is illustrated a computer system 100 comprising a trader terminal 101 used for issuing input data and being connectable via a connection 102, for example over the internet 102A or over some other means of connection like a dedicated fibre 102B, to an electronic exchange system 104. The electronic exchange system 104 is typically hosted on a computer server. Sometimes the trader terminals 101 are connected to the electronic exchange system 104 through an entry gateway 103, typically belonging to the electronic exchange system 104 and being configured to receive market actions from the trader terminals 101. Such entry gateway 103 is usually connected to the electronic exchange system 104 on a dedicated network and may forward the received market actions to the electronic exchange system 104. Further, the entry gateway 103 typically broadcasts updates to the trader terminals 101.

While the trading terminals 101 in FIG. 1 are illustrated as trading terminals which traditionally are associated with input of market actions, the trading terminals 101 may however also be implemented as an algorithmic trading unit 105, sometimes termed an automatic order generator 105; having input means enabling control of the algorithmic trading unit 105. The algorithmic trading unit 105 is typically pre-programmed with, or configured to receive, instructions to automatically generate sell-, and buy orders and quotes (or changes/cancellations thereof) in response to specific input data. Typically the specific input data is market data, such as prices and volumes of different financial instruments, and received from the electronic exchange system 104 or from some other source of information. The amount of data input messages received in an exchange of today, has increased the performance requirements that a computer system hosting an automated exchange has to meet in order to handle the received data input.

One of the reasons to why the number of market actions are increasing is that algorithmic trading has been adopted by the financial industry. An algorithmic trading unit typically adapts to changes much faster than a manual trader. High speed execution of input data is a feature that is desired by users of algorithmic trading units and as a result, the speed; in terms of round trip time for a transaction sent to an automated exchange, has significantly increased over the last couple of years.

When trading it is typically desired to complete a full trading cycle, i.e. (1. information retrieval->2. decision making->3. produce market input data (insert, delete, update order)->4. get the market action in the market) as fast as possible. By using a computerised algorithmic trading unit, a trading algorithm can take care of step number 2 and 3 in the trading cycle at a very high speed.

However, the difference in time it takes to complete step 2 and 3 of a trading cycle is negligible in comparison to the time it takes to complete step 1 and step 4. Thus in order to further improve trading speed, a few different solutions to minimize the latency in step 1 and 4 can be used. For example a trading participant can use a lot of bandwidth to have a fast communication with the exchange, or the trading participant can use a dedicated fibre link to increase its communication speed with the exchange system.

However, some trading participants place their trading server, on which the algorithm runs, as close to the actual exchange system servers as possible, thereby minimizing the number of router hops and physical distance between the trading server and the exchange system servers. For the latter, some exchange operators may even allow trading participants to place its hardware in the same physical room as the exchange servers are situated. This is in the industry known as co-location and is used by some major exchange system operators. But, even with the solutions of today, the latency brought on by step 1 and 4 of the trading cycle is rather significant, compared to the time it takes to perform step 2 and 3 of the trading cycle. Thus there is a still a desire to minimizing latency in step 1 and 4 of the trading cycle.

A further problem that arises when using an algorithmic trading unit is that with the enhanced speed, traders adapts faster to different market scenarios (retrieving information, analysing and producing market actions to counter new scenarios), hence a new burden is placed on the electronic exchange system, as its information disbursement also increases at a rapid rate, with the growing number of received input data. At the same time, the growing number of orders and quotes directed towards the exchange system also puts the exchange system under high pressure by creating latency issues as the market actions have to process and forward by the entry gateways of the exchange systems. Sometimes also other processes have to be processed before the market actions reach the core of the automated exchange system.

As electronic exchange systems have a hard time to keep up with the massive amount of messages being received and distributed, message handling constitutes a bottleneck which puts a limitation on the performance of the system. Thus, another problem with existing systems is that they have a low throughput.

These problems have, so far, been countered for by constantly upgrading the exchange system hardware. This is a costly and inefficient way of handling the described problems, as the amount of market actions will continue to increase, particularly as more and more financial participants adapt to algorithmic trading. Thus there is a need to counter for the increasing amount of market actions and information data in an efficient manner. Hence there is a need of an improved electronic exchange system that allows a higher throughput of input data messages and a lower overall latency.

### SUMMARY

An object of the embodiments of the present invention is to provide a solution improving the performance of an electronic exchange system. It is another object of the embodiments of present invention to increase the throughput of an electronic exchange system. It is yet a further object of embodiments of the present invention to minimize the latency associated with entering market actions in the form of input data messages comprising new, altered or cancelled orders and or quotes.

It is yet a further object of embodiments of the present invention to provide a solution that minimizes the hardware requirements of entry gateways of an automated exchange.

It is yet a further object of embodiments of the present invention to limit the amount of data in the information flow to-, and from the exchange system, in order to minimize bandwidth usage.

At least one of the above problems is addressed by embodiments of the present invention as set out in the appended independent claims. Advantageous embodiments are recited in the appended dependent claims.

In accordance with an exemplary embodiment an automated exchange system for matching order and quotes in a number of financial instruments is provided. The automated exchange system is arranged to receive orders and quotes via an external interface and comprises a matching module for matching the orders and the quotes, and a memory module for storing orders and quotes which are not immediately matched by the matching module. In addition it comprises an application module which is arranged to automatically generate input data messages comprising new, altered or cancelled orders and or quotes to be sent to the matching module via an internal interface. Such automated exchange system has the advantage that it makes it possible to minimize the latency normally associated with market actions being entered into the marketplace. As such, the computerized automated exchange system also provides for increased throughput. The above configuration of the automated exchange system affects the technical working of the system by reducing the sheer amount of data that have to be communicated to and from the computerized automated exchange system.

In accordance with a further embodiment, the application module comprises at least one trading module implementing an algorithmic trading unit.

In accordance with yet a further embodiment, the module implementing an algorithmic trading unit is a plug-in module.

In accordance with one embodiment, the internal interface is arranged to validate a message generated in the application module before it is sent to the matching module.

In accordance with one embodiment the internal interface is arranged to not send a message to the matching module if the message is found to be invalid.

In accordance with one embodiment market data is provided to the application module and or the trading module.

In accordance with one embodiment the trading module is adapted to receive messages via the external interface.

In accordance with one embodiment computer code of the respective at least one trading module is executed on a separate computer processor located on the same mother board as a computer processor executing code for implementing the matching of the matching module

In accordance with one embodiment computer code of the respective at least one trading module is executed in a different computer processor core of a multi core processor than the core used for executing code for implementing the matching of the matching module.

In accordance with one embodiment a method for generating input data messages comprising new, altered or cancelled orders and or quotes in an automated exchange system in a number of financial instruments is provided. The method is performed in system comprising an external interface for receiving orders and quotes, a matching module for matching orders and quotes, and a memory for storing orders and quotes not immediately matched by the matching module. The method can comprising the steps of automatically generating input data messages comprising new, altered or cancelled orders and or quotes generate in an internal application module, and sending the input data messages to the matching module via an internal interface.

In accordance with one embodiment the input data messages are generated in a trading module implementing an algorithmic trading unit.

In accordance with one embodiment the method comprises the step of validating an input data message before it is sent to the matching module.

In accordance with one embodiment a message is not sent to the matching module if said message is found not to be valid.

In accordance with one embodiment input data messages are generated in response to received market data.

In accordance with one embodiment input data messages is generated in response to messages received via the external interface.

The computer system and method as described herein has the advantage that it makes it possible for a central computer system, such as an automated electronic exchange or a trading system, to minimize the latency normally associated with market actions being entered into the marketplace. As such, the computer system also provides increased throughput. The configuration of the system affects the technical working of the system by reducing the amount of data being communicated to, and from, the computer system.

As described above the matching module may be located at a first core in a multi-core processor and the application module may be located at a second core of the same multi-core processor. Also the processors of the application module and the matching module can be served by processors located on the same mother board. For computer systems having this configuration, the latency associated with entering market actions can greatly be reduced, while the matching module still can maintain its resources.

Furthermore the computer system has the additional advantage of being scalable as it can allow for multiple trading modules, in particular plug-in trading modules to be installed into application module of the system.

Thus, this allows for proprietary plug-ins from members and third parties to be injected into the system as ordinary modules of the system are shielded from the plug-in trading modules.

The computerized automated exchange system has the advantage that it makes it possible for a full trading cycle to be performed without any data being transferred through any systems or processes outside the core parts of the computer system containing the matching module.

The automated exchange system can be provided with an interface configured to receive market data, market actions, configuration transactions and data messages feeding the application module and/or the trading module with information and instructions. The interface can be an interface connectable to a network of for instance adapted for TCP/IP connections or the alike and may further be configured to broadcast market data.

The automated exchange system can be arranged to receive market data, and to provide the data to the application module with the market data. In one embodiment market data can be received from external sources and in another it could be provided by from the matching module from within the system, after which it is provided to the application module. Thus, trading modules of the application module can use the market data in a decision making process when generating input data messages comprising new, altered or cancelled orders and or quotes in the automated exchange system.

The computer system can be arranged to receive configuration transactions, and to provide the trading units with the configuration transactions. Thus, by sending configuration transactions to the computer system a proprietor of a trading unit installed in the system can control the behaviour of the trading unit. In accordance with one embodiment all such messages can be verified by the application module before entered into a trading module.

These and other aspects of and advantages with the present invention will become apparent from the following detailed description and from the accompanying drawings.

### BRIEF DESCRIPTION OF THE DRAWINGS

In the following description of embodiments of the invention, reference will be made to the accompanying drawings of which:

FIG. 1 illustrates a computerized system for automated trading (an electronic exchange system).

FIG. 2 illustrates a computerized exchange system comprising a memory, a processor, a matching module, an application module and an adaptable code module.

FIG. 3 illustrates an automated electronic exchange system.

FIG. 4 illustrates a configuration of computer processors.

FIG. 5 illustrates procedural steps performed, in an automated electronic exchange system, when automatically generating input data messages.

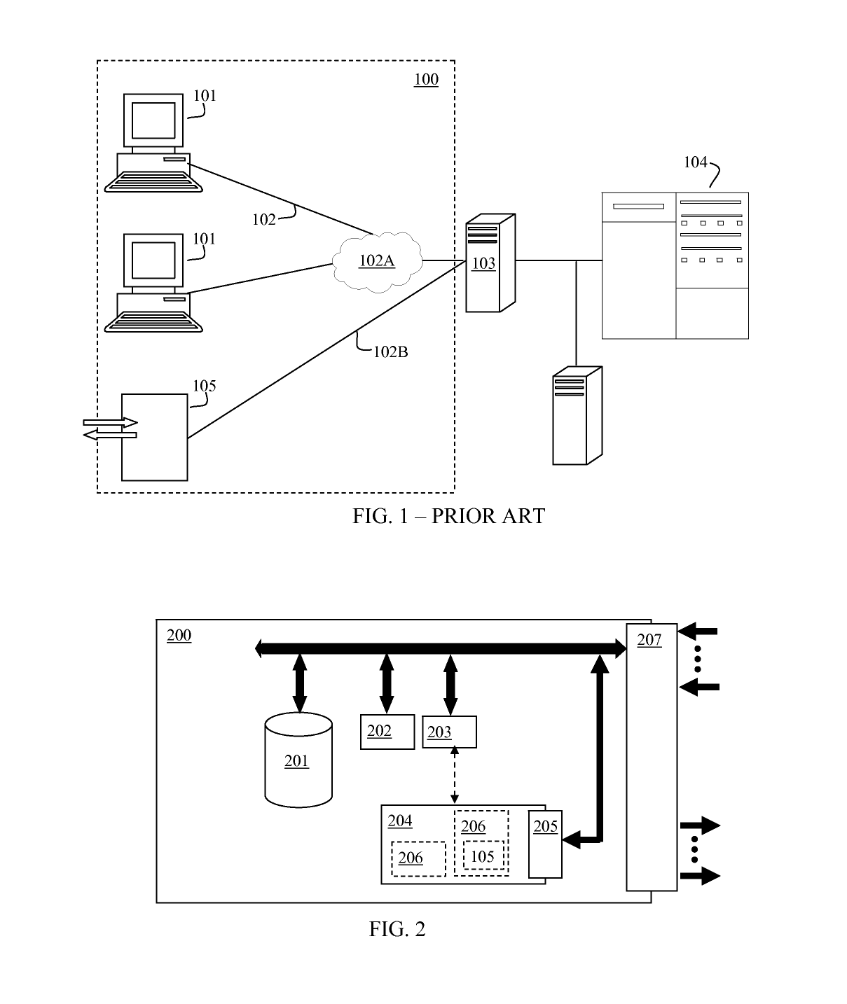

### DETAILED DESCRIPTION

Embodiments of present invention will now be described in detail. As should be noted in present application, when the term “financial instrument” is used, it is used in a broad sense, refers to and encompasses, any tradable item i.e. securities, derivative or commodity, such as stocks, bonds, cash, swaps, futures, foreign exchange options, gas electricity and so forth, or group of items that is traded through matching of counterparty orders (bid, offer).

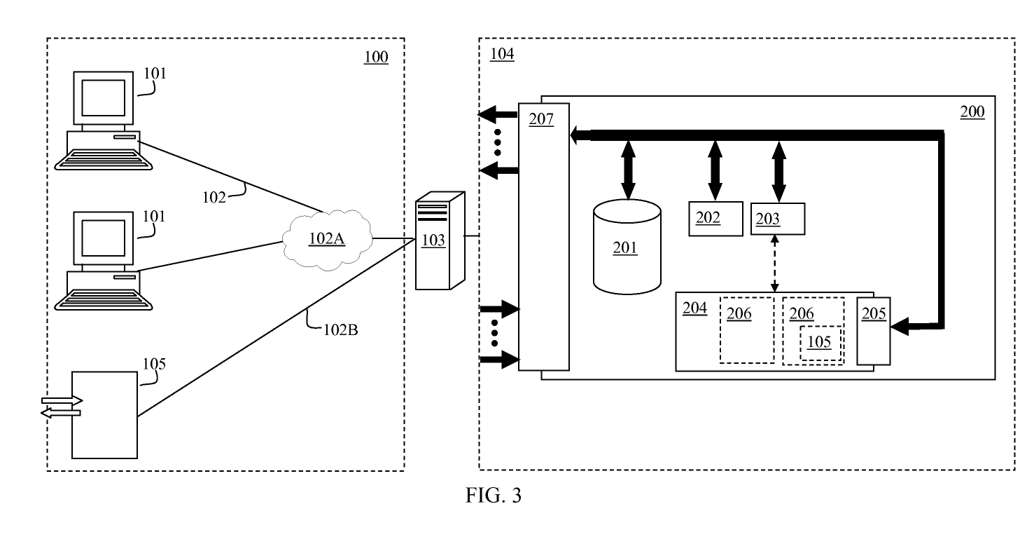

FIG. 2 illustrates a computer system 200 implementing an example of an automated electronic exchange system 104. The computer system 200 is typically implemented on a computer server, or the like. In an embodiment of the invention the computer system 200 comprises a memory module 201, a processor circuit 202 and a matching module 203. The memory module 201 is arranged to store different data for the automated electronic exchange system 104. In particular the memory module 201 is able to store an order book comprising matchable sell/buy orders and quotes, not already matched by the matching module 203. The computer system 200 implementing an example of an automated electronic exchange system 104 further comprises a matching module 203 for matching orders and an application module 204 for entering input data messages. The input data messages comprising new, altered or cancelled orders and or quotes which are entered into the matching module 203. The modules 203, 204, 206 are implemented either as dedicated hardware or as software instructions contained in a memory allocation and executed by the processor 202. While in FIG. 2 only one processor 202 and one memory 201 are shown, the computer system 200 may be configured with several processors 202 and/or several memories 201, interconnected according to normal practices in the field of computer science. However, for sake of clarity, only one of each is shown. The automated electronic exchange system 104 may comprise a computer, or server, system comprising one or more processors configured to work as a central electronic exchange system; i.e. a central electronic market place, for matching of various financial instruments. The computer system 200 is, through an external interface 207, connected to a network, the network is however not illustrated in FIG. 2.

FIG. 3 shows the network, comprising conventional network means, as well as front end hardware and applications, such as trading systems and trading terminals 101. The trading terminals 101 are used for submitting market actions (i.e. input data messages comprising new, altered or cancelled orders and or quotes) to the electronic automated exchange system 104. The modules 203, 204, 206 and interfaces 205, 207 may comprise both hardware and software components. For example the matching module 203 may comprise a computer program, or part of a computer program, stored at a memory allocation and a processor may access the computer program, such that the methods according to the present invention can be performed. The processor can be a standard processor or the like, or the processor can be a multi-core processor, depending on application. The matching module 203 is further connected to the application module 204 and to an external interface 207; the matching module can, as such, receive input data messages from both the application module and via the external interface 207. The application module 204 further comprises a trading module 206 implementing an algorithmic trading unit. The trading module 206 is, for this purpose, programmed to automatically generate input data messages comprising new, altered or cancelled orders and or quotes, which are entered into the matching module 203 via a first interface 205.

In a further embodiment of the invention there are more than one trading modules 206, implementing one or more algorithmic trading units.

The input data messages are automatically generated in the application module 204 (for example by a trading module 206) may be generated in response to a data fed to the application module 204. The internal interface 205 may be implemented using a module approach and arranged to receive and transmit data messages, to and from the rest of the computer system 200. By interface is generally meant a point of interaction between components, and is applicable at the level of both hardware and software. This allows a component, whether a piece of hardware or a piece of software, to function independently while using interfaces to communicate with other components via an input/output system and an associated protocol. In particular the internal interface 205 transmits input data messages comprising new, altered or cancelled orders and or quotes to the matching modules and to receive data relating to price, volume and the like associated with different financial instruments traded in the computer system 200. In accordance with one embodiment of the invention, the internal interface 205 also acts as a validation module, arranged to validate all data generated by the trading modules 206 of the application module 204 and transmitted into the computer system 200 and in particular the matching module 203. Hereby it is possible to prevent invalid messages from enter the matching module 203 when generated in the application module 204.

The computer code associated with the different trading modules 206 can be provided by a party, external to the proprietor of the system 200. Thus, in an example embodiment of the invention, while the computer system 200 is hosted and run by as an electronic automated exchange system 104, the code in a trading module 206 may be provided, as a trading algorithm, from an external participant, trading within the computer system 200. The algorithmic trading unit 105 can then be implemented in the trading module 206 and plugged-in to the system via the application module 204, for example as a so-called binary plug-in. Parameters and settings of computer code of the module 206 can be altered, either automatically in response to data in particular market data such as price, volume etc., received from within the system 200 via the interface 205, or via the external interface 207. Parameters and settings can also be altered via an external command message, received via the external interface 207. This will be explained in more detail below.

FIG. 3 further illustrates the computer system 200 implemented on a computer server when connected to a number of trading terminals/trading units 101. The computer system 200 hosted on the computer server and implementing an automated exchange system 104 is in connection with trader terminals 101 through the entry gateway 103. The computer system 200 comprises a matching module 203 for matching orders and an application module 204 for entering input data messages comprising new, altered or cancelled orders and or quotes. As explained above the internal application module 204 of the automated exchange system 200 can comprise one or many trading modules 206 implementing algorithmic trading units 105 of different trading participants. The different trading participants can, in accordance with one embodiment, alter the behaviour of the modules 206 by changing the computer program, executed within the modules, by using a command message transmitted via the external interface 207. The command messages transmitted to change the behaviour of the computer program may for example be changes of parameters and settings, used by the code, implementing an algorithmic trading unit 105 within a particular trading module 206. The command messages may further be validated by the application module 204 before being allowed to enter a particular trading module 206.

In accordance with one embodiment the trading modules 206 are plug-in modules that easily can be removed from the module 204. Hereby it is possible to change the complete software algorithm running in a module 206 with a minor of interruptions.

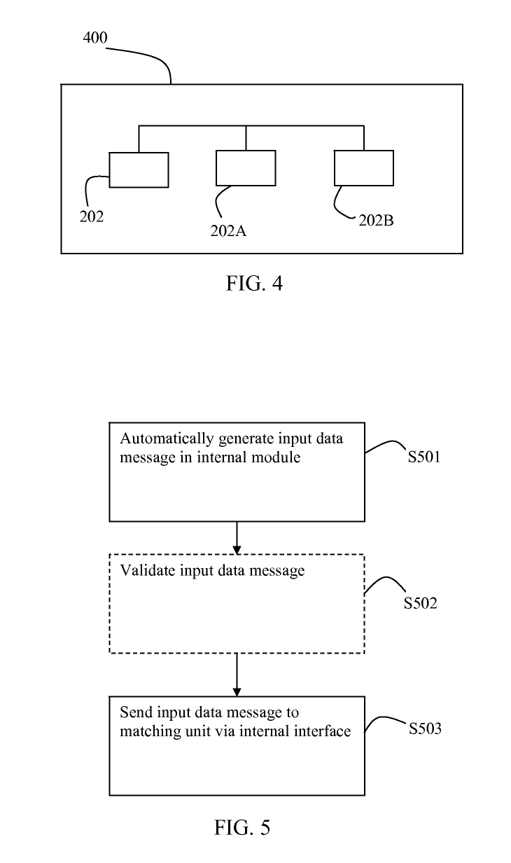

FIG. 4 illustrates, in accordance with one embodiment of the invention, the application module 204 and/or trading modules 206 are executing software using processors physically located on the same motherboard as the processor 202 executing the code implementing the matching module. In an embodiment of the invention, a set-up comprising a processor 202 associated with a matching module 203 is depicted on a motherboard 400 together with processors 202A and 202A, where processors 202A and 202B are associated with the trading modules 206 and designated to execute the software code of the modules 206. Additional processors can of course be provided to execute the code of an application module 204 or additional trading modules 206. Hereby is practically achieved a minimum of time delay, when input data messages comprising new, altered or cancelled orders and or quotes are generated by the modules 204, 206 until they reach the matching module 203, implemented by code and executed by the processor 202. In accordance with a further embodiment, the processors 202, 202A and 202B are not different physical processors, but rather implemented using different cores of a multi-core processor 202.

In FIG. 5 some procedural steps are described and performed when automatically generating an input data message comprising new, altered or cancelled orders and or quotes in an automated exchange system 200 as described above in a number of financial instruments are illustrated. First in a step S501 an input data message corresponding to a new, altered or cancelled order or quote is automatically generated in an internal application module of the system 200. Next in a step S502 the input data message can be validated to confirm that it is a valid data message that can be processed in the matching module 203 of the computer system 200 without causing the matching module 203 to malfunction. An input data message not being validated can be discarded. Thereupon the input data message is sent to the matching module 203 via the internal interface 205 in a step S503.

It should be noted that in the description above the term “comprising” does not exclude other elements or steps and “a” or “an” does not exclude a plurality. Furthermore it should be noted that the terms “include” and “contain” does not exclude other elements or steps. The present invention is not limited to the above-described preferred embodiments. Various alternatives, modifications and equivalents may be used. Therefore, the above embodiments should not be taken as limiting the scope of the invention, which is defined by the appended claims.

1. An automated electronic exchange system (200), enabling matching of orders and quotes in a number of financial instruments, the automated electronic exchange system (200) arranged to receive orders and quotes via an external interface (207), the automated exchange system (200) comprising:
a processor means (202);
a matching module (203), arranged to enable matching of orders and quotes;
a memory module (201), configured to storing orders and quotes which are not immediately matched by the matching module (203);
an internal interface (205); and
an application module (204) arranged to automatically generate and send input data messages comprising new, altered or cancelled orders and, or, quotes to be sent to the matching module (203) via the internal, interface (205).

2. The system according to claim 1, wherein the application module (204) comprises a trading module (206) implementing an algorithmic trading unit (105).

3. The system according to claim 2, wherein the trading module (206) implementing an algorithmic trading unit (105) is a plug-in module.

4. The system according to claim 1, wherein the internal interface (205) is arranged to validate the data message generated in the application module (204) before the data message is sent to the matching module (203).

5. The system according to claim 4, wherein the internal interface (205) is arranged to not send the data message to the matching module (203) if said data message is found not to be valid by the internal interface (205).

6. The system according to claim 1, wherein the application module (204) and/or the trading module (206) is/are adapted to receive market data.

7. The system according to claim 1, wherein the application module (204) comprises a trading module (206) and wherein the trading module (206) is adapted to receive data messages via the external interface (207).

8. The system according to claim 1, wherein the application module (204) comprises a trading module (206), further comprising:
a separate computer processor (202A, 202B) located on the same mother board as the computer processor (202) for executing code implementing matching of the matching module (206), wherein the separate processor (202A,202B) is arranged to execute computer code of the respective trading modules (206); or
a multi-core processor (202,202A,202B) wherein the computer code of the respective trading module (206) is executed in a different processor core (202A,202B) of the multi-core processor (202,202A,202B) than the processor core (202) used for executing code for implementing the matching of the matching module (203).

9. A method for automatically generating input data messages comprising new, altered or cancelled orders and or quotes in an automated exchange system (200) in a number of financial instruments, the system comprising an external interface (207) for receiving orders and quotes, a matching module (203) for matching orders and quotes, and a memory (201) for storing orders and quotes not immediately matched by the matching module, the method comprising the following steps:
automatically generating (S501) input data messages comprising new, altered or cancelled orders and or quotes in an internal application module, and
sending (S503) the input data messages to the matching module (203) via an internal interface (205).

10. The method according to claim 9, wherein the input data messages are generated in a trading module (206) implementing an algorithmic trading unit (105).

11. The method according to claim 10, further comprising the step of validating (S502) an input data message before it is sent to the matching module (203).

12. The method according to claim 11, wherein the data message is not sent to the matching module (203) if said message is found to be invalid.

13. The method according to claim 9, wherein input data messages are generated in response to received market data.

14. The method according to claim 9, wherein input data messages are generated in response to command messages received via the external interface (207).
